(19) United States
(12) Patent Application Publication
(10) Pub. No.: US 2025/0309723 A1
(43) Pub. Date: Oct. 2, 2025

(54) ROTATING ELECTRICAL MACHINE

(71) Applicant: NIDEC CORPORATION, Kyoto (JP)

(72) Inventors: Shigeru MAEDA, Kyoto (JP); Aoi FUKUDA, Kyoto (JP)

(21) Appl. No.: 19/087,584

(22) Filed: Mar. 24, 2025

(30) Foreign Application Priority Data
Mar. 29, 2024 (JP) 2024-057776

(51) Int. Cl. H02K 3/52

(52) U.S. Cl. CPC H02K 3/522; H02K 2203/06; H02K 2203/09

(57) ABSTRACT

A rotating electrical machine of the present disclosure includes a rotor rotatable about a central axis, a stator including a coil portion made from a first material and facing the rotor with a gap interposed therebetween, a substrate that supplies power to the coil portion, a bus bar electrically connected to the substrate and made from a second material different from the first material, and a connection member fixed to the bus bar and electrically connecting the coil portion and the bus bar. The coil portion includes a coil main body portion mounted on the stator and a coil lead wire drawn out from the coil main body portion. The connection member includes a housing portion that accommodates the coil lead wire in the inside, and a pressing portion that presses the coil lead wire against an inner surface of the housing portion.

### CROSS-REFERENCE TO RELATED APPLICATIONS

The present invention claims priority under 35 U.S.C. § 119 to Japanese Patent Application No. 2024-057776 filed on Mar. 29, 2024, the entire content of which is incorporated herein by reference.

### FIELD OF THE INVENTION

The present disclosure relates to a rotating electrical machine.

### BACKGROUND

As one of conventional electric motors, there is an electric motor including a bus bar that electrically connects a coil attached to a stator core and a motor drive unit that supplies power to the coil. Further, there is an electric motor in which a coil and a bus bar are joined by welding.

In a conventional electric motor, in a case where a coil and a bus bar are made from materials different from each other, a melting point of the coil and a melting point of the bus bar are different from each other, and it is difficult to join the coil and the bus bar by welding. Therefore, it is difficult to stably and electrically connect the coil and a motor drive unit via the bus bar, which has made it difficult to enhance stability of operation of the motor.

### SUMMARY

One aspect of an exemplary rotating electrical machine of the present disclosure includes a rotor rotatable about a central axis, a stator including a coil portion made from a first material and facing the rotor with a gap interposed between them, a substrate that supplies power to the coil portion, a bus bar electrically connected to the substrate and made from a second material different from the first material, and a connection member fixed to the bus bar and electrically connecting the coil portion and the bus bar. The coil portion includes a coil main body portion mounted on the stator and a coil lead wire drawn out from the coil main body portion. The connection member includes a housing portion that accommodates the coil lead wire in the inside, and a pressing portion that presses the coil lead wire against an inner surface of the housing portion.

The above and other elements, features, steps, characteristics and advantages of the present disclosure will become more apparent from the following detailed description of the preferred embodiments with reference to the attached drawings.

### BRIEF DESCRIPTION OF THE DRAWINGS

FIG. 1 is a cross-sectional view illustrating a rotating electrical machine of a first embodiment;

FIG. 2 is a cross-sectional view of a stator of the first embodiment, taken along line II-II in FIG. 1;

FIG. 3 is a perspective view illustrating the stator of the first embodiment;

FIG. 4 is a perspective view illustrating a bus bar of the first embodiment;

FIG. 5 is a perspective view illustrating a connection member of the first embodiment;

FIG. 6 is a view illustrating the connection member and a coil lead wire of the first embodiment;

FIG. 7 is a perspective view illustrating the connection member of a second embodiment;

FIG. 8 is a view illustrating the connection member and the coil lead wire of the second embodiment;

FIG. 9 is a perspective view illustrating the connection member of a third embodiment;

FIG. 10 is a view illustrating the connection member and the coil lead wire of the third embodiment;

FIG. 11 is a perspective view illustrating the connection member of a fourth embodiment;

FIG. 12 is a view illustrating the connection member and the coil lead wire of the fourth embodiment;

FIG. 13 is a perspective view illustrating the connection member of a fifth embodiment; and

FIG. 14 is a view illustrating the connection member and the coil lead wire of the fifth embodiment.

### DETAILED DESCRIPTION

Hereinafter, a rotating electrical machine according to an embodiment of the present disclosure will be described with reference to the drawings. Note that the scope of the present disclosure is not limited to an embodiment below and may be changed as appropriate within the technical idea of the present disclosure. Further, in drawings below, scales, numbers, and the like may be made different from those of actual structures in order to facilitate understanding of each configuration.

Each of the drawings illustrates a Z axis appropriately in description below. The Z axis is a direction in which a central axis J of an embodiment described below extends. The central axis J illustrated in each drawing is a virtual axis. In description below, a direction in which the central axis J extends, that is, a direction parallel to the Z axis is referred to as an “axial direction”. A radial direction about the central axis J is simply referred to as a “radial direction”. A circumferential direction about the central axis J is simply referred to as a “circumferential direction”. In the axial direction, a side to which an arrow of the Z axis is directed (+Z side) is referred to as an “upper side”. In the axial direction, a side opposite to the side to which an arrow of the Z axis is directed (−Z side) is referred to as a “lower side”. Note that the upper side and the lower side are simply terms for describing a relative positional relationship of each portion, and thus an actual placement relationship and the like may be other than the placement relationship and the like indicated by these terms.

The circumferential direction is indicated by an arrow θ in each drawing. In the circumferential direction, a side to which the arrow θ is directed is referred to as “one side in the circumferential direction”. Of the circumferential direction, a side opposite to the side to which the arrow θ is directed is referred to as “another side in the circumferential direction”. The one side in the circumferential direction (+8 side) is a side proceeding clockwise around the central axis J when viewed from the upper side. The another side in the circumferential direction (−θ side) is a side proceeding counterclockwise around the central axis J when viewed from the upper side.

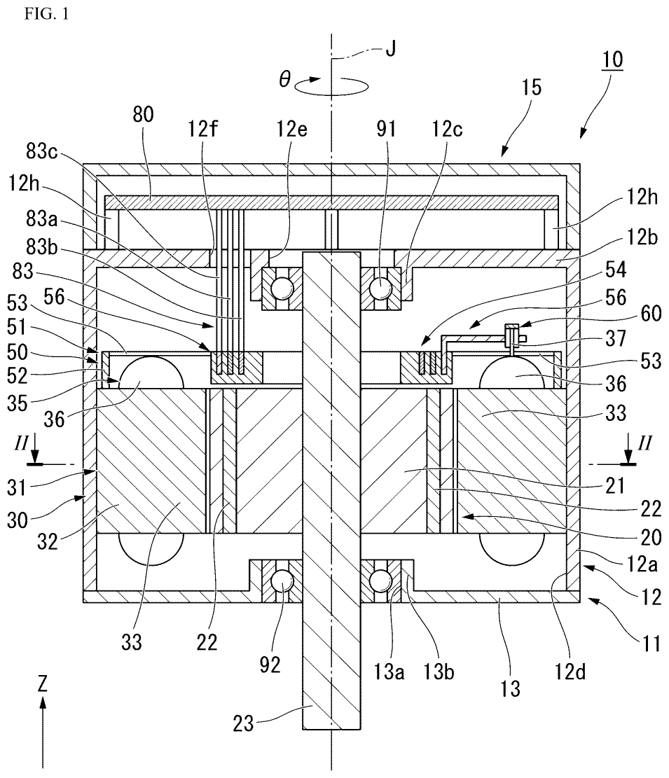

A rotating electrical machine 10 of the present embodiment illustrated in FIG. 1 is a motor to be attached to a device or the like mounted on a vehicle. The device to which the rotating electrical machine 10 is attached may be an automatic transmission or a vehicle drive device that drives an axle of a vehicle. The rotating electrical machine 10 of the present embodiment is a three-phase motor. The three phases are a U phase, a V phase, and a W phase. The rotating electrical machine 10 includes a housing 11, a rotor 20, a stator 30, a bus bar unit 50, a connection member 60, a substrate 80, a connection terminal 83, a first bearing 91, and a second bearing 92.

The housing 11 accommodates each part of the rotating electrical machine 10 such as the rotor 20 and the stator 30 in the inside. The housing 11 includes a cylindrical portion 12, a lower cover portion 13, and an upper cover portion 15.

The cylindrical portion 12 has a cylindrical shape surrounding the central axis J. The cylindrical portion 12 has an opening portion 12d that opens downward. Each part of the rotating electrical machine 10 such as the rotor 20 and the stator 30 is accommodated in the cylindrical portion 12. The cylindrical portion 12 has a peripheral wall portion 12a and an upper wall portion 12b. The peripheral wall portion 12a has a substantially cylindrical shape extending in the axial direction around the central axis J. The peripheral wall portion 12a surrounds the rotor 20 and the stator 30 from the outer side in the radial direction.

The upper wall portion 12b has a substantially annular plate shape around the central axis J. A plate surface of the upper wall portion 12b faces the axial direction. An outer edge in the radial direction of the upper wall portion 12b is connected to an upper end of the peripheral wall portion 12a. The upper wall portion 12b is provided with a first bearing holding portion 12c, a first hole portion 12e, a second hole portion 12f, and a plurality of substrate holding portions 12h. The first hole portion 12e is a hole penetrating the upper wall portion 12b in the axial direction. When viewed from the axial direction, the first hole portion 12e has a substantially circular shape around the central axis J.

The first bearing holding portion 12c protrudes downward from an edge portion of the first hole portion 12e in the upper wall portion 12b. The first bearing holding portion 12c has a substantially cylindrical shape around the central axis J. The first bearing holding portion 12c opens downward. The first bearing 91 is attached to an inner peripheral surface of the first bearing holding portion 12c. The second hole portion 12f is a hole penetrating the upper wall portion 12b in the axial direction. The second hole portion 12f is provided further on the outer side in the radial direction than the first bearing holding portion 12c.

Each of the substrate holding portions 12h has a columnar shape protruding upward from the upper wall portion 12b. The substrate holding portions 12h are arranged at intervals along the circumferential direction. The substrate holding portions 12h hold the substrate 80.

The lower cover portion 13 has a substantially annular plate shape around the central axis J. The lower cover portion 13 is fixed to a lower end of the cylindrical portion 12. The lower cover portion 13 closes the opening portion 12d from below. The lower cover portion 13 is provided with a third hole portion 13a and a second bearing holding portion 13b. The third hole portion 13a is a hole that penetrates the lower cover portion 13 in the axial direction. When viewed from the axial direction, the third hole portion 13a has a substantially circular shape around the central axis J.

The second bearing holding portion 13b protrudes upward from an edge portion of the third hole portion 13a of the lower cover portion 13. The second bearing holding portion 13b has a substantially cylindrical shape around the central axis J. The second bearing holding portion 13b opens upward. The second bearing 92 is attached to an inner peripheral surface of the second bearing holding portion 13b.

The upper cover portion 15 has a substantially cylindrical shape extending in the axial direction around the central axis J. The upper cover portion 15 opens downward. The substrate 80 is accommodated inside the upper cover portion 15. A lower end of the upper cover portion 15 is fixed to an upper end of the peripheral wall portion 12a. By this, the upper cover portion 15 is fixed to the cylindrical portion 12.

Each of the first bearing 91 and the second bearing 92 has an annular shape around the central axis J. In the present embodiment, each of the first bearing 91 and the second bearing 92 is a ball bearing. Each of the first bearing 91 and the second bearing 92 may be a plain bearing.

The rotor 20 is rotatable about the central axis J. In the present embodiment, the rotor 20 is arranged further on the inner side in the radial direction than the stator 30. The rotor 20 faces the stator 30 with a gap between them in the radial direction. The rotor 20 may be arranged on the outer side in the radial direction of the stator 30. The rotor 20 includes a rotor core 21, a magnet 22, and a shaft 23.

The rotor core 21 has a substantially annular shape around the central axis J. The rotor core 21 faces the stator 30 with a gap between them in the radial direction. A plurality of magnets 22 are fixed to the rotor core 21. The magnets 22 are arranged at intervals along the circumferential direction.

The shaft 23 has a substantially cylindrical shape extending in the axial direction around the central axis J. An outer peripheral surface of the shaft 23 is fixed to an inner peripheral surface of the rotor 20. An upper end of the shaft 23 is rotatably supported around the central axis J by the first bearing 91. A portion on the lower side of the shaft 23 is rotatably supported around the central axis J by the second bearing 92. Due to these, the shaft 23 is rotatable about the central axis J. Therefore, the rotor 20 is rotatable about the central axis J. A lower end of the shaft 23 passes through the third hole portion 13a in the axial direction and is located outside the housing 11.

The substrate 80 has a plate shape extending in a direction orthogonal to the axial direction. The substrate 80 is arranged inside the upper cover portion 15. The substrate 80 is held by the substrate holding portions 12h. By this, the housing 11 holds the substrate 80. The substrate 80 is electrically connected to an external power supply (not illustrated). Power is supplied to the substrate 80 from the external power supply. The substrate 80 is electrically connected to the stator 30. The substrate 80 supplies power supplied from the external power supply to the stator 30.

The stator 30 is arranged further on the outer side in the radial direction than the rotor 20. The stator 30 faces the rotor 20 with a gap between them in the radial direction. However, the stator 30 may be arranged on the inner side in the radial direction of the rotor 20. The stator 30 is fixed to an inner peripheral surface of the peripheral wall portion 12a. The stator 30 includes a stator core 31, a coil portion 35, and an insulator (not illustrated).

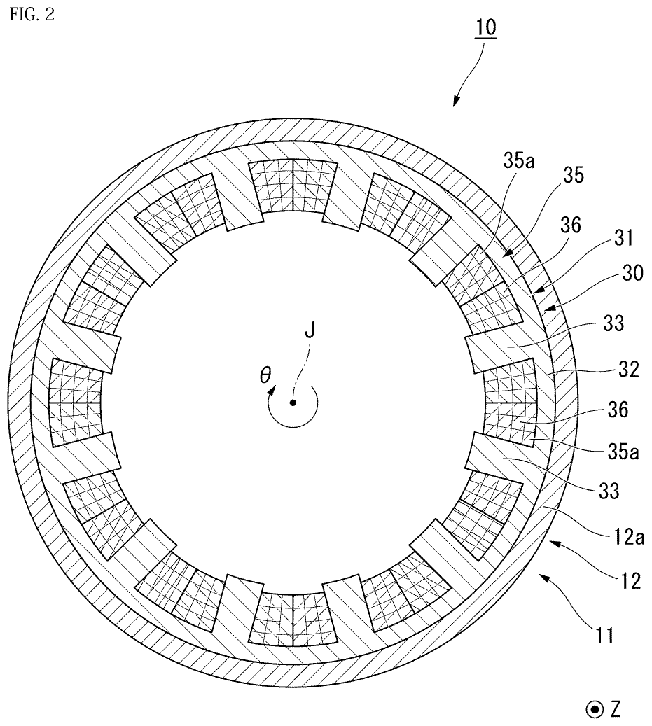

The stator core 31 has a substantially annular shape about the central axis J. The stator core 31 surrounds the rotor 20 from the outside in the radial direction. The stator core 31 faces the rotor 20 with a gap between them in the radial direction. As illustrated in FIG. 2, the stator core 31 includes a core back portion 32 and a plurality of tooth portions 33.

The core back portion 32 has a substantially annular shape around the central axis J. An outer peripheral surface of the core back portion 32 is fixed to an inner peripheral surface of the peripheral wall portion 12a. By this, the stator 30 is held by the housing 11. Each of the tooth portions 33 protrudes to the inner side in the radial direction from the core back portion 32. When viewed from the axial direction, each of the tooth portions 33 has a substantially rectangular shape whose long side extends in the radial direction. As illustrated in FIG. 1, each of the tooth portions 33 is arranged with a gap from the rotor core 21 in the radial direction. As illustrated in FIG. 2, in the present embodiment, the stator core 31 includes 12 tooth portions 33. The number of the tooth portions 33 included in the stator core 31 may be 11 or less or 13 or more. The tooth portions 33 are arranged at substantially equal intervals along the circumferential direction.

Power is supplied from the substrate 80 to the coil portion 35. That is, the substrate 80 supplies power to the coil portion 35. The coil portion 35 includes a coil wire 35a. In the present embodiment, the coil wire 35a is a rectangular wire having a substantially square cross-sectional shape. The coil wire 35a may be a round wire having a substantially circular cross-sectional shape. In the present embodiment, the coil wire 35a is made from aluminum. In the present embodiment, aluminum is a first material M1. Therefore, the coil portion 35 is made from the first material M1. As illustrated in FIG. 1, the coil portion 35 includes a coil main body portion 36 and a coil lead wire 37.

As illustrated in FIG. 2, the coil main body portion 36 is amounted on the tooth portion 33 with an insulator (not illustrated) interposed between them. By this, the coil main body portion 36 is mounted on the stator 30. The coil main body portion 36 includes the coil wire 35a wound around an insulator. In the present embodiment, the coil portion 35 has 12 of the coil main body portions 36. The coil main body portions 36 are mounted on the tooth portions 33 different from each other. The coil main body portions 36 are arranged at substantially equal intervals along the circumferential direction. Twelve of the coil main body portions 36 constitute three-phase coils of four systems. That is, the rotating electrical machine 10 includes four of the coil main body portions 36 of a U phase, four of the coil main body portions 36 of a V phase, and four of the coil main body portions 36 of a W phase. The number of the coil main body portions 36 of each phase may be three or less or five or more. When power is supplied to the coil main body portion 36, the coil main body portion 36 and the tooth portion 33 constitute an electromagnet in which a magnetic pole faces the radial direction.

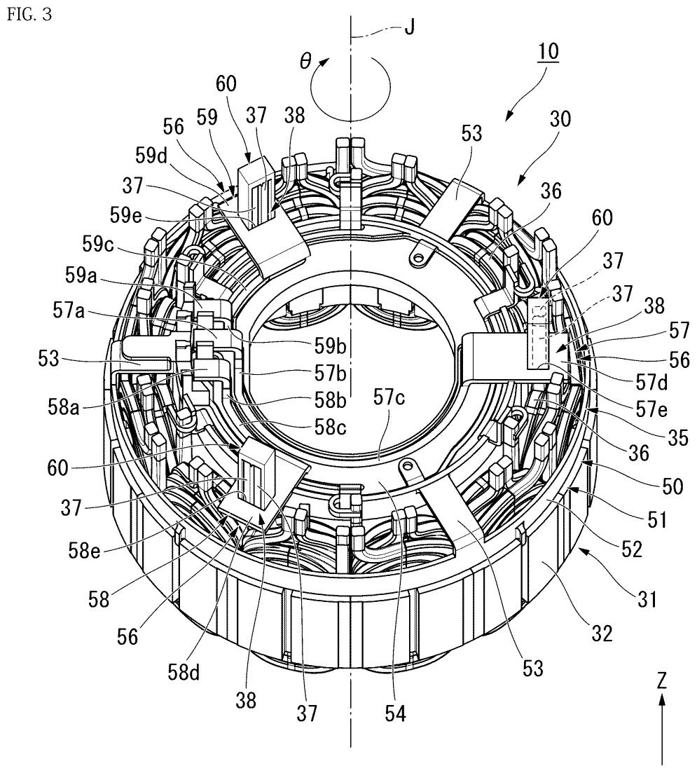

As illustrated in FIG. 1, the coil lead wire 37 is a coil wire drawn upward from the coil main body portion 36. A direction in which the coil lead wire 37 extends is the axial direction. In the present embodiment, the coil portion 35 includes six of the coil lead wires 37. As illustrated in FIG. 3, the coil lead wires 37 are arranged along the circumferential direction. In the present embodiment, six coil lead wires constitute three coil lead wire groups 38. One of the coil lead wire groups 38 has two of the coil lead wires 37. Two of the coil lead wires 37 included in one of the coil lead wire groups 38 are arranged side by side in the circumferential direction. Three of the coil lead wire groups 38 are arranged at substantially equal intervals along the circumferential direction.

As illustrated in FIG. 1, the bus bar unit 50 has a substantially annular shape about the central axis J. The bus bar unit 50 is accommodated in the cylindrical portion 12. The bus bar unit 50 is arranged above the stator core 31. The bus bar unit 50 is fixed to the stator core 31. The bus bar unit 50 includes a bus bar holding portion 51 and a bus bar 56. Therefore, the rotating electrical machine 10 includes the bus bar 56.

The bus bar holding portion 51 has a substantially annular shape about the central axis J. The bus bar holding portion 51 holds the bus bar 56. The bus bar holding portion 51 is made from resin. In the present embodiment, the bus bar holding portion 51 is molded by insert molding using the bus bar 56 as an insert member. A part of the bus bar 56 is embedded inside the bus bar holding portion 51. The bus bar holding portion 51 includes a fixing portion 52, a connection plate portion 53, and an annular portion 54.

The fixing portion 52 has a substantially cylindrical shape extending in the axial direction about the central axis J. The fixing portion 52 opens on both sides in the axial direction. The fixing portion 52 is arranged further on the outer side in the radial direction than the coil main body portions 36. A lower end of the fixing portion 52 is fixed to a surface facing the upper side of the stator core 31. By this, the bus bar unit 50 is fixed to the stator core 31.

The connection plate portion 53 has a plate shape extending in the radial direction. A plate surface of the connection plate portion 53 faces the axial direction. As illustrated in FIG. 3, the bus bar holding portion 51 includes three of the connection plate portions 53. When viewed from the axial direction, each of the connection plate portions 53 has a substantially rectangular shape whose long side extends in the radial direction. The connection plate portions 53 are arranged above the coil main body portion 36. An end portion on the outer side in the radial direction of each of the connection plate portions 53 is connected to the fixing portion 52. An end portion on the inner side in the radial direction of each of the connection plate portions 53 is connected to the annular portion 54. By the above, each of the connection plate portions 53 connects the fixing portion 52 and the annular portion 54.

As illustrated in FIG. 1, the annular portion 54 has a substantially annular shape about the central axis J. The annular portion 54 is arranged above the rotor core 21. The annular portion 54 is arranged further on the inner side in the radial direction than each of the coil main body portions 36. A part of the bus bar 56 is embedded inside the annular portion 54. By this, the annular portion 54 holds the bus bar 56. That is, the bus bar holding portion 51 holds the bus bar 56.

The bus bar 56 illustrated in FIG. 3 is a plate-shaped conductor. In the present embodiment, the bus bar 56 is made from copper. In the present embodiment, copper is a second material M2. Therefore, the bus bar 56 is made from the second material M2 different from aluminum, that is, the first material M1. Note that the bus bar 56 may be made from gold or silver. As described above, the coil portion 35 is made from aluminum. Therefore, the bus bar 56 is made from a material different from that of the coil portion 35. For this reason, a melting point of the bus bar 56 and a melting point of the coil portion 35 are different from each other.

The bus bar unit 50 includes a plurality of the bus bars 56. In the present embodiment, the bus bar unit 50 includes three of the bus bars 56. A plurality of the bus bars 56 include a first bus bar 57, a second bus bar 58, and a third bus bar 59. Each of the first bus bar 57, the second bus bar 58, and the third bus bar 59 is a phase bus bar. The first bus bar 57 is a U-phase bus bar. The first bus bar 57 is electrically connected to four of the coil main body portions 36 of a U phase. The second bus bar 58 is a V-phase bus bar. The second bus bar 58 is electrically connected to four of the coil main body portions 36 of a V phase. The third bus bar 59 is a W-phase bus bar. The third bus bar 59 is electrically connected to four of the coil main body portions 36 of a W phase.

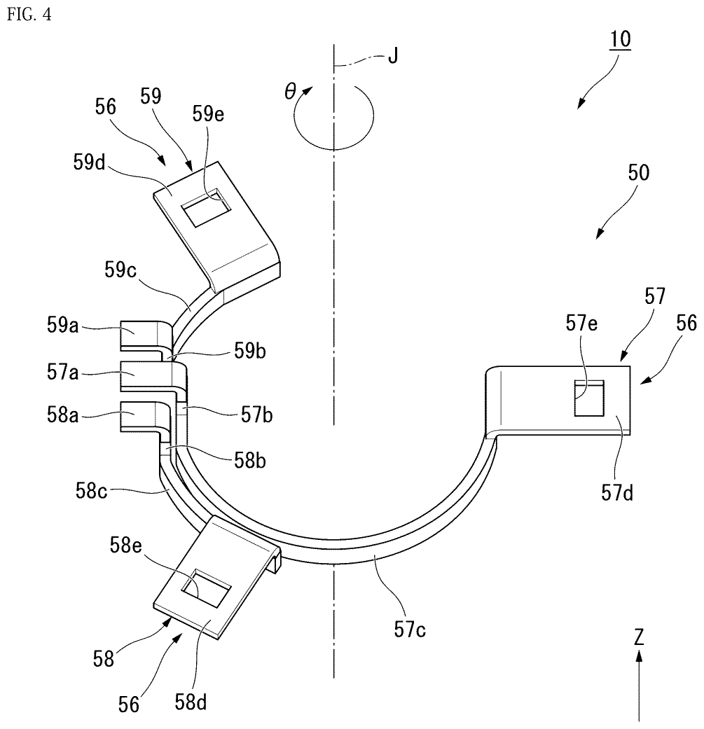

As illustrated in FIG. 4, the first bus bar 57 includes a power supply terminal portion 57a, a connection portion 57b, a main body portion 57c, and a terminal portion 57d. The power supply terminal portion 57a has a plate shape extending in a direction orthogonal to the axial direction. As illustrated in FIG. 3, the power supply terminal portion 57a is located above the annular portion 54. As illustrated in FIG. 4, the connection portion 57b has a plate shape extending downward from an inner edge in the radial direction of the power supply terminal portion 57a. A plate surface of the connection portion 57b faces the radial direction.

The main body portion 57c has a substantially arc shape extending from a lower end of the connection portion 57b to the another side in the circumferential direction (−θ side) by substantially 180°. The main body portion 57c has a plate shape with a plate surface facing the radial direction. As illustrated in FIG. 3, the main body portion 57c is embedded in the annular portion 54. A surface facing the upper side of the main body portion 57c is exposed to the outside of the annular portion 54.

The terminal portion 57d has a plate shape protruding outward in the radial direction from an end portion on the another side in the circumferential direction of the main body portion 57c. A plate surface of the terminal portion 57d faces the axial direction. When viewed from the axial direction, the terminal portion 57d has a substantially rectangular shape whose long side extends in the radial direction. As illustrated in FIG. 3, the terminal portion 57d is arranged above the annular portion 54. As illustrated in FIG. 4, the terminal portion 57d has a hole portion 57e. That is, the bus bar 56 has the hole portion 57e. The hole portion 57e is a hole penetrating the terminal portion 57d in the axial direction. When viewed from the axial direction, the hole portion 57e has a substantially rectangular shape.

The second bus bar 58 includes a power supply terminal portion 58a, a connection portion 58b, a main body portion 58c, and a terminal portion 58d. The power supply terminal portion 58a has a plate shape extending in a direction orthogonal to the axial direction. The power supply terminal portion 58a is arranged further on the another side in the circumferential direction (−θ side) than the power supply terminal portion 57a. The power supply terminal portion 58a is arranged side by side with the power supply terminal portion 57a in the circumferential direction. As illustrated in FIG. 3, the power supply terminal portion 58a is located above the annular portion 54. As illustrated in FIG. 4, the connection portion 58b has a plate shape extending downward from an inner edge in the radial direction of the power supply terminal portion 58a. A plate surface of the connection portion 58b faces the radial direction.

The main body portion 58c has a substantially arc shape extending from a lower end of the connection portion 58b to the another side in the circumferential direction (−θ side) by substantially 60°. The main body portion 58c has a plate shape with a plate surface facing the radial direction. The main body portion 58c is arranged further on the outer side in the radial direction of the main body portion 57c. As illustrated in FIG. 3, the main body portion 58c is embedded in the annular portion 54. A surface of the main body portion 58c facing the upper side is exposed to the outside of the annular portion 54.

The terminal portion 58d has a plate shape protruding outward in the radial direction from an end portion on the another side in the circumferential direction of the main body portion 58c. A plate surface of the terminal portion 58d faces the axial direction. When viewed from the axial direction, the terminal portion 58d has a substantially rectangular shape whose long side extends in the radial direction. As illustrated in FIG. 3, the terminal portion 58d is arranged above the annular portion 54. As illustrated in FIG. 4, the terminal portion 58d has a hole portion 58e. That is, the bus bar 56 has the hole portion 58e. The hole portion 58e is a hole penetrating the terminal portion 58d in the axial direction. When viewed from the axial direction, the hole portion 58e is a substantially rectangular hole.

The third bus bar 59 includes a power supply terminal portion 59a, a connection portion 59b, a main body portion 59c, and a terminal portion 59d. The power supply terminal portion 59a has a plate shape extending in a direction orthogonal to the axial direction. The power supply terminal portion 59a is arranged further on the one side in the circumferential direction (+θ side) than the power supply terminal portion 57a. The power supply terminal portion 59a is arranged side by side with the power supply terminal portion 57a in the circumferential direction. As illustrated in FIG. 3, the power supply terminal portion 59a is located above the annular portion 54. As illustrated in FIG. 4, the connection portion 59b has a plate shape extending downward from an inner edge in the radial direction of the power supply terminal portion 59a. A plate surface of the connection portion 59b faces the radial direction.

The main body portion 59c has a substantially arc shape extending from a lower end of the connection portion 59b to the one side in the circumferential direction (+θ side) by substantially 60°. The main body portion 59c has a plate shape with a plate surface facing the radial direction. As illustrated in FIG. 3, the main body portion 59c is embedded in the annular portion 54. A surface of the main body portion 59c facing the upper side is exposed to the outside of the annular portion 54.

The terminal portion 59d has a plate shape protruding outward in the radial direction from an end portion on the one side in the circumferential direction of the main body portion 59c. A plate surface of the terminal portion 59d faces the axial direction. When viewed from the axial direction, the terminal portion 59d has a substantially rectangular shape whose long side extends in the radial direction. As illustrated in FIG. 3, the terminal portion 59d is arranged above the annular portion 54. The terminal portions 57d, 58d, and 59d are arranged at substantially equal intervals along the circumferential direction. As illustrated in FIG. 4, the terminal portion 59d has a hole portion 59e. That is, the bus bar 56 has the hole portion 59e. The hole portion 59e is a hole penetrating the terminal portion 59d in the axial direction. When viewed from the axial direction, the hole portion 59e is a substantially rectangular hole.

The connection terminal 83 illustrated in FIG. 1 electrically connects the bus bar 56 and the substrate 80. The connection terminal 83 has a plate shape extending in the axial direction. The connection terminal 83 is made from metal. The connection terminal 83 passes through the second hole portion 12f in the axial direction. The connection terminal 83 includes a first connection terminal 83a, a second connection terminal 83b, and a third connection terminal 83c. An upper end of each of the first connection terminal 83a, the second connection terminal 83b, and the third connection terminal 83c is connected to the substrate 80. A lower end of the first connection terminal 83a is connected to the power supply terminal portion 57a illustrated in FIG. 3. By this, the first bus bar 57 is electrically connected to the substrate 80 via the first connection terminal 83a. A lower end of the second connection terminal 83b is connected to the power supply terminal portion 58a illustrated in FIG. 3. By this, the second bus bar 58 is electrically connected to the substrate 80 via the second connection terminal 83b. A lower end of the third connection terminal 83c is connected to the power supply terminal portion 59a illustrated in FIG. 3. By this, the third bus bar 59 is electrically connected to the substrate 80 via the third connection terminal 83c. Therefore, the bus bar 56 is electrically connected to the substrate 80 via the connection terminal 83.

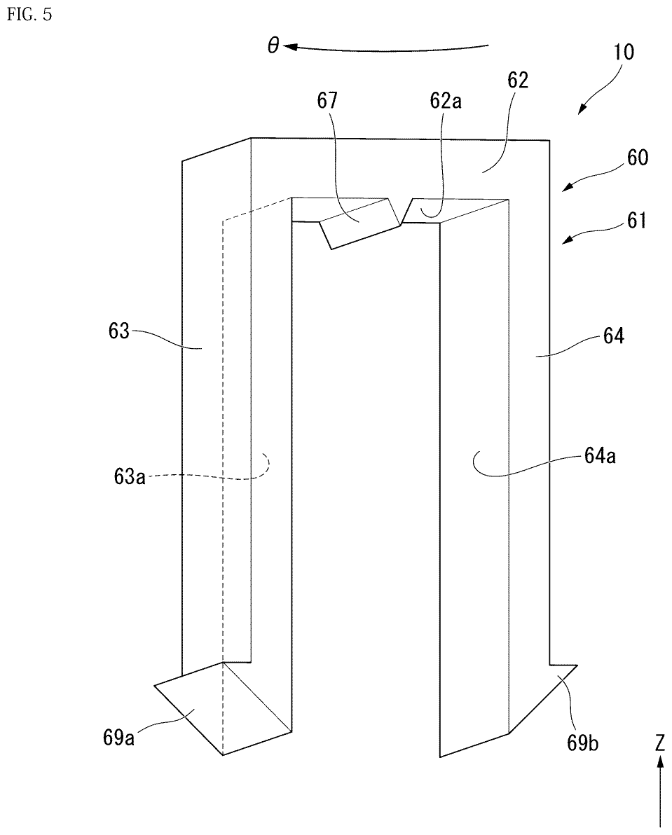

As illustrated in FIG. 5, the connection member 60 has a substantially rectangular parallelepiped shape extending in the axial direction. When viewed from the axial direction, the connection member 60 has a substantially rectangular shape whose long side extends in a direction orthogonal to the radial direction. In the present embodiment, the connection member 60 is made from copper. That is, the connection member 60 is made from the second material M2 different from aluminum, that is, the first material M1. The connection member 60 is made from the same material as the bus bar 56. As illustrated in FIG. 3, in the present embodiment, the rotating electrical machine 10 includes three of the connection members 60. The connection members 60 are arranged at substantially equal intervals along the circumferential direction. The connection members 60 pass through the hole portions 57e, 58e, and 59e different from each other in the axial direction. The connection members 60 are fixed to the terminal portions 57d, 58d, and 59d different from each other. That is, the connection member 60 is fixed to the bus bar 56. The connection members 60 are electrically connected to the coil lead wire groups 38 different from each other. That is, the connection member 60 is electrically connected to the coil portion 35. By the above, the connection member 60 electrically connects the coil portion 35 and the bus bar 56. As illustrated in FIG. 5, the connection member 60 includes a housing portion 61, a pressing portion 67, and protruding portions 69a and 69b. Note that, in description below, a configuration in which the connection member 60 is fixed to the terminal portion 57d will be described. A configuration in which the connection member 60 is fixed to the terminal portion 58d and a configuration in which the connection member 60 is fixed to the terminal portion 59d are similar to the configuration in which the connection member 60 is fixed to the terminal portion 57d, and thus, are omitted from description.

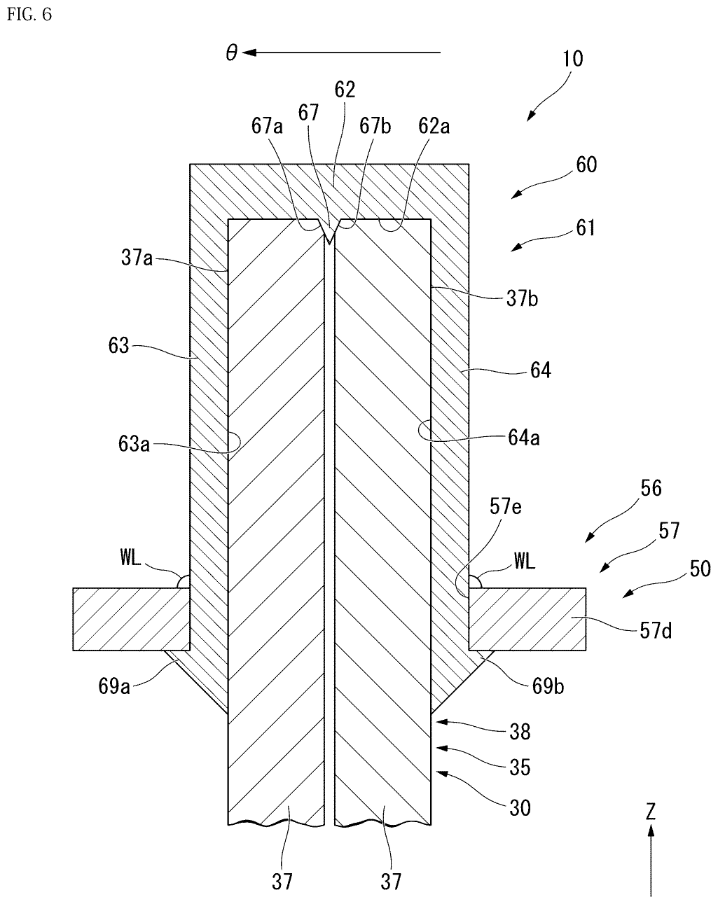

As illustrated in FIG. 6, the housing portion 61 accommodates the coil lead wire group 38 in the inside. That is, the housing portion 61 accommodates the coil lead wire 37 in the inside. The housing portion 61 includes a top wall portion 62 and side wall portions 63 and 64. As illustrated in FIG. 5, the top wall portion 62 has a plate shape extending in a direction orthogonal to the axial direction. A plate surface of the top wall portion 62 faces the axial direction. When viewed from the axial direction, the top wall portion 62 has a substantially rectangular shape whose long side extends in a direction orthogonal to the radial direction. As illustrated in FIG. 6, the top wall portion 62 is arranged above the terminal portion 57d. The top wall portion 62 has a top surface 62a. The top surface 62a is a surface facing the lower side of the top wall portion 62. The top surface 62a expands in the axial direction, that is, in a direction intersecting a direction in which the coil lead wire 37 extends. In the present embodiment, the top surface 62a expands in a direction orthogonal to the axial direction. The top surface 62a is an inner surface of the housing portion 61.

As illustrated in FIG. 5, the side wall portion 63 has a plate shape extending downward from an end portion on the one side in the circumferential direction (+θ side) of the top wall portion 62. The side wall portion 64 has a plate shape extending downward from an end portion on the another side in the circumferential direction (−θ side) of the top wall portion 62. A plate surface of each of the side wall portions 63 and 64 faces a direction orthogonal to the radial direction. When viewed from a direction orthogonal to the radial direction, each of the side wall portions 63 and 64 has a substantially rectangular shape in which a long side extends in the axial direction. As illustrated in FIG. 6, each of the side wall portions 63 and 64 passes through the hole portion 57e in the axial direction. By this, the connection member 60 passes through the hole portion 57e. In the present embodiment, each of the side wall portions 63 and 64 is press-fitted into the hole portion 57e. That is, the connection member 60 is press-fitted into the hole portion 57e. By this, the connection member 60 and the bus bar 56 can be electrically connected to each other. Further, since a contact area between the connection member 60 and the bus bar 56 can be made large, contact resistance between the connection member 60 and the bus bar 56 can be reduced. As described above, the first bus bar 57 is electrically connected to the substrate 80 via the first connection terminal 83a. Therefore, the connection member 60 is electrically connected to the substrate 80 via the first bus bar 57 and the first connection terminal 83a. Therefore, the connection member 60 is electrically connected to the substrate 80 via the bus bar 56 and the connection terminal 83.

Each of the side wall portions 63 and 64 is fixed to the terminal portion 57d by welding. A joint portion WL illustrated in FIG. 6 is a portion where a part of each of the side wall portions 63 and 64 and a part of the terminal portion 57d are joined by welding. As described above, each of the bus bar 56 and the connection member 60 is made from copper. Therefore, in the present embodiment, since the connection member 60 and the bus bar 56 are made from the same material, a difference between a melting point of the connection member 60 and a melting point of the bus bar 56 can be made small. By this, the connection member 60 can be firmly fixed to the bus bar 56 by welding.

The side wall portion 63 has a first inner surface 63a. The first inner surface 63a is a surface facing the another side in the circumferential direction (−θ side) of the side wall portion 63. The side wall portion 64 has a first inner surface 64a. The first inner surface 64a is a surface facing the one side in the circumferential direction (+θ side) of the side wall portion 64. Each of the first inner surfaces 63a and 64a is an inner surface of the housing portion 61. As described above, the top surface 62a is an inner surface of the housing portion 61. Therefore, an inner surface of the housing portion 61 includes the top surface 62a and the first inner surfaces 63a and 64a.

As illustrated in FIG. 5, the pressing portion 67 is a protrusion protruding downward from the top wall portion 62. The pressing portion 67 has a triangular prism shape extending in the radial direction. When viewed from the radial direction, the pressing portion 67 has a triangular shape in which one corner portion is positioned below the other two corner portions. As illustrated in FIG. 6, the pressing portion 67 has inclined surfaces 67a and 67b. Each of the inclined surfaces 67a and 67b is an outer surface of the pressing portion 67. The inclined surface 67a is a surface facing the one side in the circumferential direction (+θ side) in an outer surface of the pressing portion 67. The inclined surface 67a is an inclined surface located further on the one side in the circumferential direction as it approaches the upper side. The inclined surface 67b is a surface facing the another side in the circumferential direction (−θ side) in an outer surface of the pressing portion 67. The inclined surface 67b is an inclined surface located further on the another side in the circumferential direction as it approaches the upper side.

The coil lead wire group 38 passes through the hole portion 57e in the axial direction, and is arranged inside the housing portion 61. Inside the housing portion 61, two of the coil lead wires 37 of the coil lead wire group 38 are arranged side by side in the circumferential direction. One of the coil lead wires 37 is arranged further on the one side in the circumferential direction (+θ side) than another one of the coil lead wires 37. The first inner surface 63a faces a first coil side surface 37a of one of the coil lead wires 37. The first coil side surface 37a is a surface facing the one side in the circumferential direction in a side surface of one of the coil lead wires 37. The first inner surface 64a faces a second coil side surface 37b of another one of the coil lead wires 37. The second coil side surface 37b is a surface facing the another side in the circumferential direction (−θ side) in a side surface of another one of the coil lead wires 37. Each of the first coil side surface 37a and the second coil side surface 37b is a side surface of the coil lead wire 37. Note that, in the present embodiment, a side surface of the coil lead wire 37 is a surface facing a direction orthogonal to a direction in which the coil lead wire 37 extends.

A tip portion of one of the coil lead wires 37 is arranged between the side wall portion 63 and the pressing portion 67. A dimension in a direction orthogonal to the radial direction of the coil lead wire 37 is larger than a dimension between the first inner surface 63a and an upper end of the inclined surface 67a. For this reason, a tip portion of one of the coil lead wires 37 is press-fitted into the first inner surface 63a and the inclined surface 67a. By this, one of the coil lead wires 37 is pressed against the first inner surface 63a by the pressing portion 67. More specifically, the first coil side surface 37a of one of the coil lead wires 37 is pressed against the first inner surface 63a. Further, a tip portion of another one of the coil lead wires 37 is arranged between the side wall portion 64 and the pressing portion 67. A dimension in a direction orthogonal to the radial direction of the coil lead wire 37 is larger than a dimension between the first inner surface 64a and an upper end of the inclined surface 67b. For this reason, a tip portion of another one of the coil lead wires 37 is press-fitted into the first inner surface 64a and the inclined surface 67b. By this, another one of the coil lead wires 37 is pressed against the first inner surface 64a by the pressing portion 67. More specifically, the second coil side surface 37b of another one of the coil lead wires 37 is pressed against the first inner surface 64a. From the above, the pressing portion 67 presses a side surface of the coil lead wire 37 against the first inner surfaces 63a and 64a. As described above, each of the first inner surfaces 63a and 64a is an inner surface of the housing portion 61. Therefore, the pressing portion 67 presses the coil lead wire 37 against an inner surface of the housing portion 61. By this, each of the coil lead wires 37 is electrically connected to the connection member 60. As described above, the connection member 60 is electrically connected to the substrate 80 via the bus bar 56 and the connection terminal 83. By these, the coil portion 35 is electrically connected to the substrate 80, and power is supplied from the substrate 80 to the coil portion 35.

The protruding portion 69a protrudes from a lower end of the side wall portion 63 to the one side in the circumferential direction (+θ side). The protruding portion 69b protrudes from a lower end of the side wall portion 64 to the another side in the circumferential direction (−θ side). A surface facing the upper side of each of the protruding portions 69a and 69b contacts a surface facing the lower side of the terminal portion 57d in the axial direction. By this, a position in the axial direction of the connection member 60 with respect to the terminal portion 57d is determined.

According to the present embodiment, the rotating electrical machine 10 includes the stator 30 including the coil portion 35 made from the first material M1 and facing the rotor 20 via a gap, the substrate 80 that supplies power to the coil portion 35, the bus bar 56 electrically connected to the substrate 80 and made from the second material M2 different from the first material M1, and the connection member 60 fixed to the bus bar 56 and electrically connecting the coil portion 35 and the bus bar 56. The coil portion 35 includes the coil main body portion 36 mounted on the stator 30 and the coil lead wire 37 drawn out from the coil main body portion 36, and the connection member 60 includes the housing portion 61 that accommodates the coil lead wire 37 in the inside and the pressing portion 67 that presses the coil lead wire 37 against an inner surface of the housing portion 61. In a case where the coil portion 35 and the bus bar 56 are made from materials different from each other, since a melting point of the coil lead wire 37 and a melting point of the bus bar 56 are at temperatures different from each other, it is difficult to directly join the coil lead wire 37 and the bus bar 56 by welding. On the other hand, in the present embodiment, since the coil lead wire 37 can be pressed against an inner surface of the connection member 60 by the pressing portion 67, the coil lead wire 37 and the connection member 60 can be stably and electrically connected. Furthermore, since the connection member 60 is fixed to the bus bar 56, the connection member 60 and the bus bar can be stably and electrically connected. By these, the coil lead wire 37 and the bus bar 56 can be stably and electrically connected via the connection member 60. Therefore, even in a case where the coil portion 35 and the bus bar 56 are made from materials different from each other, the coil portion 35 and the bus bar 56 can be stably and electrically connected via the connection member 60. By this, power can be stably supplied from the substrate 80 to the coil portion 35, so that stability of operation of the rotating electrical machine 10 can be enhanced.

Further, in the present embodiment, the coil portion 35 is made from aluminum. For this reason, as compared with a case where the coil portion 35 is made from copper, material cost of the coil portion 35 can be reduced, and weight of the coil portion 35 can be reduced. Therefore, it is possible to stably and electrically connect the coil portion 35 and the bus bar 56 while reducing weight and reducing manufacturing cost of the rotating electrical machine 10.

According to the present embodiment, an inner surface of the housing portion 61 includes the top surface 62a that expands in a direction intersecting a direction in which the coil lead wire 37 extends, and the first inner surfaces 63a and 64a facing the first coil side surface 37a and the second coil side surface 37b of the coil lead wire 37, that is, a side surface of the coil lead wire 37, and the pressing portion 67 is a protrusion that protrudes from the top surface 62a and presses a side surface of the coil lead wire 37 against the first inner surfaces 63a and 64a. Therefore, since a side surface of the coil lead wire 37 can be pressed against the first inner surfaces 63a and 64a by the pressing portion 67, a contact area between the coil lead wire 37 and the connection member 60 can be easily increased. By this, it is possible to suppress increase in contact resistance between the coil lead wire 37 and the connection member 60. Therefore, even in a case where the coil portion 35 and the bus bar 56 are made from materials different from each other, the coil portion 35 and the bus bar 56 can be more stably and electrically connected via the connection member 60.

Further, in the present embodiment, since the pressing portion 67 is a part of the connection member 60, it is possible to suppress increase in the number of components of the rotating electrical machine 10 as compared with a case where a separate member for pressing the coil lead wire 37 against the connection member 60 is additionally provided. Therefore, it is possible to suppress increase in manufacturing cost and the number of manufacturing steps of the rotating electrical machine 10.

According to the present embodiment, the bus bar 56 has the hole portions 57e, 58e, and 59e through which the connection member 60 passes, and the connection members 60 are press-fitted into the hole portions 57e, 58e, and 59e. Therefore, the connection member 60 can be fixed to the bus bar 56 by simple work of press-fitting the connection member 60 into the hole portions 57e, 58e, and 59e. For this reason, it is possible to suppress increase in the number of components of the rotating electrical machine 10 as compared with a configuration in which the connection member 60 is fixed to the bus bar 56 by a fastening member such as a bolt, for example. By these, it is possible to more preferably suppress increase in manufacturing cost and the number of manufacturing steps of the rotating electrical machine 10.

Further, according to the present embodiment, as described above, since a contact area between the connection member 60 and the bus bar 56 can be made large, contact resistance between the connection member 60 and the bus bar 56 can be reduced. By this, it is possible to suppress increase in contact resistance between the connection member 60 and the bus bar 56. Therefore, even in a case where the coil portion 35 and the bus bar 56 are made from materials different from each other, the coil portion 35 and the bus bar 56 can be more stably and electrically connected via the connection member 60.

According to the present embodiment, the connection member 60 is made from the second material M2 and is fixed to the bus bar 56 by welding. In the present embodiment, since the connection member 60 and the bus bar 56 are made from the same material, a difference between a melting point of the connection member 60 and a melting point of the bus bar 56 can be made small. By this, the connection member 60 can be firmly fixed to the bus bar 56 by welding. For this reason, even if vibration of the rotor 20 is transmitted to each of the connection member 60 and the bus bar 56 during operation of the rotating electrical machine 10, the connection member 60 and the bus bar 56 can be stably and electrically connected. Therefore, even in a case where the coil portion 35 and the bus bar 56 are made from materials different from each other, the coil portion 35 and the bus bar 56 can be more stably and electrically connected via the connection member 60.

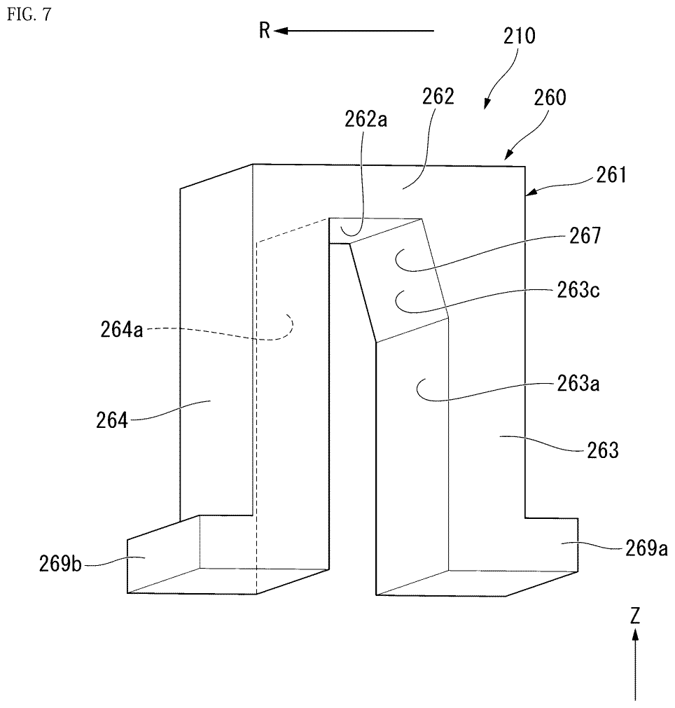

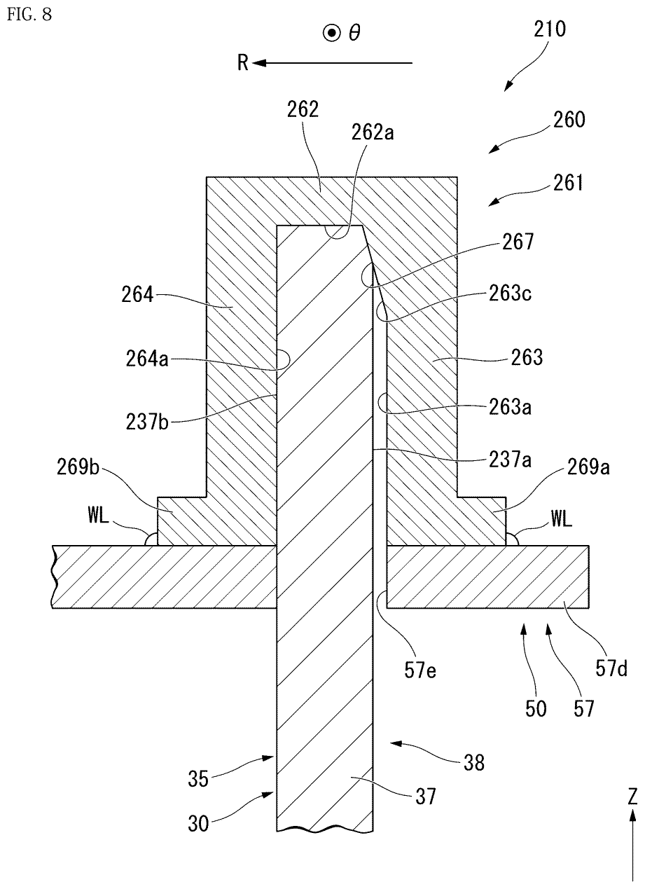

As illustrated in FIG. 7, a rotating electrical machine 210 of the present embodiment includes a connection member 260. In description below, the same reference numerals are given to constituent elements of the same aspects as those of the above-described embodiment, and the description of those will be omitted. Note that the radial direction is indicated by an arrow R in FIGS. 7 and 8. The side to which the arrow R is directed in the radial direction is the inner side in the radial direction. The side opposite to the side to which the arrow R is directed in the radial direction is the outer side in the radial direction.

As illustrated in FIG. 7, the connection member 260 has a substantially rectangular parallelepiped shape extending in the axial direction. When viewed from the axial direction, the connection member 260 has a substantially rectangular shape whose long side extends in the radial direction. In the present embodiment, the connection member 260 is made from copper. Each of the connection member 260 and the bus bar 56 is made from the second material M2. Although not illustrated, the rotating electrical machine 210 includes three of the connection members 260. The connection members 260 are fixed to the terminal portions 57d, 58d, and 59d different from each other. That is, the connection member 260 is fixed to the bus bar 56. The connection member 260 includes a housing portion 261, a pressing portion 267, and protruding portions 269a and 269b.

As illustrated in FIG. 8, the housing portion 261 accommodates the coil lead wire 37 in the inside. The housing portion 261 includes a top wall portion 262 and side wall portions 263 and 264. As illustrated in FIG. 7, the top wall portion 262 has a plate shape extending in a direction orthogonal to the axial direction. When viewed from the axial direction, the top wall portion 262 has a substantially rectangular shape whose long side extends in the radial direction. As illustrated in FIG. 8, the top wall portion 262 has a top surface 262a. The top surface 262a is a surface facing the lower side of the top wall portion 262. The top surface 262a is an inner surface of the housing portion 261.

As illustrated in FIG. 7, the side wall portion 263 has a plate shape extending downward from an end portion on the outer side in the radial direction (−R side) of the top wall portion 262. The side wall portion 264 has a plate shape extending downward from an end portion on the inner side in the radial direction (+R side) of the top wall portion 262. A plate surface of each of the side wall portions 263 and 264 faces the radial direction. When viewed from the radial direction, each of the side wall portions 263 and 264 has a substantially rectangular shape whose long side extends in the axial direction. As illustrated in FIG. 8, each of the side wall portions 263 and 264 is located above the terminal portion 57d. A lower end of the side wall portions 263 and 264 is in contact with the terminal portion 57d in the axial direction. Accordingly, the connection member 260 and the bus bar 56 can be electrically connected to each other. Therefore, the connection member 260 is electrically connected to the substrate 80 via the bus bar 56 and the connection terminal 83. Further, a position in the axial direction of the connection member 260 with respect to the terminal portion 57d is determined.

The side wall portion 263 has a first inner surface 263a. The first inner surface 263a is a surface facing the inner side in the radial direction (+R side) of the side wall portion 263. The side wall portion 264 has a second inner surface 264a. The second inner surface 264a is a surface facing the outer side in the radial direction (−R side) of the side wall portion 264. The second inner surface 264a faces the first inner surface 263a in the radial direction. An inner surface of the housing portion 261 includes the top surface 262a, the first inner surface 263a, and the second inner surface 264a.

The first inner surface 263a has an inclined surface 263c. The inclined surface 263c is a portion on the upper side of the first inner surface 263a. The inclined surface 263c is an inclined surface located closer to the second inner surface 264a side as it approaches the upper side, that is, the tip side of the coil lead wire 37. In the present embodiment, the pressing portion 267 is the inclined surface 263c.

The coil lead wire group 38 passes through the hole portion 57e in the axial direction, and is arranged inside the housing portion 261. Inside the housing portion 261, two of the coil lead wires 37 of the coil lead wire group 38 are arranged side by side in the circumferential direction. A side surface of the coil lead wire 37 includes a first coil side surface 237a and a second coil side surface 237b. The first coil side surface 237a is a surface facing the outer side in the radial direction (−R side) in a side surface of the coil lead wire 37. The first inner surface 263a faces the first coil side surface 237a. The second coil side surface 237b is a surface facing the inner side in the radial direction (+R side) in a side surface of the coil lead wire 37. The second coil side surface 237b faces the side opposite to the first coil side surface 237a. The second inner surface 264a faces the second coil side surface 237b.

A tip portion of each of the coil lead wires 37 is arranged between the pressing portion 267 and the second inner surface 264a. A dimension in the radial direction of the coil lead wire 37 is larger than a dimension between an upper end of the pressing portion 267 and the second inner surface 264a. For this reason, a tip portion of each of the coil lead wires 37 is press-fitted into the pressing portion 267 and the second inner surface 264a. By this, each of the coil lead wires 37 is pressed against the second inner surface 264a by the pressing portion 267. More specifically, the pressing portion 267 presses the second coil side surface 237b against the second inner surface 264a. As described above, the second inner surface 264a is an inner surface of the housing portion 261. Therefore, the pressing portion 267 presses each of the coil lead wires 37 against an inner surface of the housing portion 261. By this, each of the coil lead wires 37 is electrically connected to the connection member 260. Therefore, the coil portion 35 is electrically connected to the substrate 80.

The protruding portion 269a protrudes outward in the radial direction (−R side) from a lower end of the side wall portion 263. The protruding portion 269b protrudes inward in the radial direction (+R side) from a lower end of the side wall portion 264. That is, the protruding portions 269a and 269b protrude from the housing portion 261 toward the outside of the housing portion 261. A surface facing the lower side of the protruding portions 269a and 269b are in contact with a surface facing the upper side of the terminal portion 57d in the axial direction. By this, a position in the axial direction of the connection member 260 with respect to the terminal portion 57d is determined. The protruding portions 269a and 269b are fixed to the terminal portion 57d by welding. The joint portion WL illustrated in FIG. 8 is a portion where a part of each of the protruding portions 269a and 269b and a part of the terminal portion 57d are joined by welding. By this, the protruding portions 269a and 269b are fixed to the bus bar 56 by welding. The other configurations and the like of the connection member 260 of the present embodiment are similar to the other configurations and the like of the connection member 60 of the first embodiment described above. The other configurations and the like of the rotating electrical machine 210 of the present embodiment are similar to the other configurations and the like of the rotating electrical machine 10 of the first embodiment described above.

As described above, in the present embodiment, since each of the connection member 260 and the bus bar 56 is made from the second material M2, a difference between a melting point of the connection member 260 and a melting point of the bus bar 56 can be made small similarly to the first embodiment described above. By this, the connection member 260 can be firmly fixed to the bus bar 56 by welding. Therefore, even in a case where the coil portion 35 and the bus bar 56 are made from materials different from each other, the coil portion 35 and the bus bar 56 can be stably and electrically connected via the connection member 260.

According to the present embodiment, a side surface of the coil lead wire 37 includes the first coil side surface 237a and the second coil side surface 237b facing the side opposite to the first coil side surface 237a, an inner surface of the housing portion 261 includes the first inner surface 263a facing the first coil side surface 237a and the second inner surface 264a facing the second coil side surface 237b, the first inner surface 263a has the inclined surface 263c positioned closer to the second inner surface 264a side toward the tip side of the coil lead wire 37, and the pressing portion 267 is the inclined surface 263c and presses the second coil side surface 237b against the second inner surface 264a. Therefore, since a side surface of the coil lead wire 37 can be pressed against the second inner surface 264a by the pressing portion 267, a contact area between the coil lead wire 37 and the connection member 260 can be easily increased. By this, it is possible to suppress increase in contact resistance between the coil lead wire 37 and the connection member 260. Therefore, even in a case where the coil portion 35 and the bus bar 56 are made from materials different from each other, the coil portion 35 and the bus bar 56 can be stably and electrically connected via the connection member 260.

Further, in the present embodiment, since the pressing portion 267 is a part of the connection member 260, it is possible to suppress increase in the number of components of the rotating electrical machine 210 as compared with a case where a separate member for pressing the coil lead wire 37 against the connection member 260 is additionally provided. Therefore, increase in manufacturing cost of the rotating electric machine 210 can be suppressed.

According to the present embodiment, the connection member 260 has the protruding portions 269a and 269b protruding from the housing portion 261 toward the outside of the housing portion 261, and the protruding portions 269a and 269b are fixed to the bus bar 56 by welding. As compared with a case where the connection member 260 does not have the protruding portions 269a and 269b, that is, a case where the connection member 260 has a rectangular cylindrical shape, it is easy to bring a welding machine close to the joint portion WL between the connection member 260 and the bus bar 56. For this reason, it is possible to suppress increase in the number of work steps for welding the connection member 260 and the bus bar 56. Therefore, it is possible to suitably suppress increase in the number of manufacturing steps of the rotating electrical machine 210.

Note that, in the present embodiment, the pressing portion 267 may be provided on a portion on the upper side of the second inner surface 264a. In this case, the pressing portion 267 is an inclined surface closer to the first inner surface 263a side as it approaches the upper side. In this case, the pressing portion 267 presses the first coil side surface 237a against the first inner surface 263a.

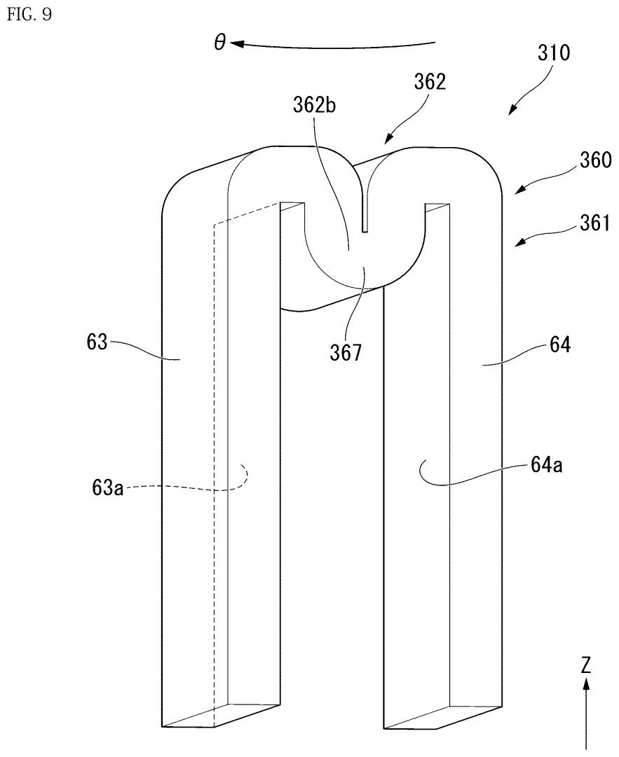

As illustrated in FIG. 9, a rotating electrical machine 310 of the present embodiment includes a connection member 360. In description below, the same reference numerals are given to constituent elements of the same aspects as those of the above-described embodiment, and the description of those will be omitted.

As illustrated in FIG. 9, the connection member 360 has a substantially rectangular parallelepiped shape extending in the axial direction. In the present embodiment, the connection member 360 is made from copper. Each of the connection member 360 and the bus bar 56 is made from the second material M2. Although not illustrated, the rotating electrical machine 310 includes three of the connection members 360. The connection members 360 are fixed to the terminal portions 57d, 58d, and 59d different from each other. That is, the connection member 360 is fixed to the bus bar 56. The connection member 360 includes a housing portion 361 and a pressing portion 367.

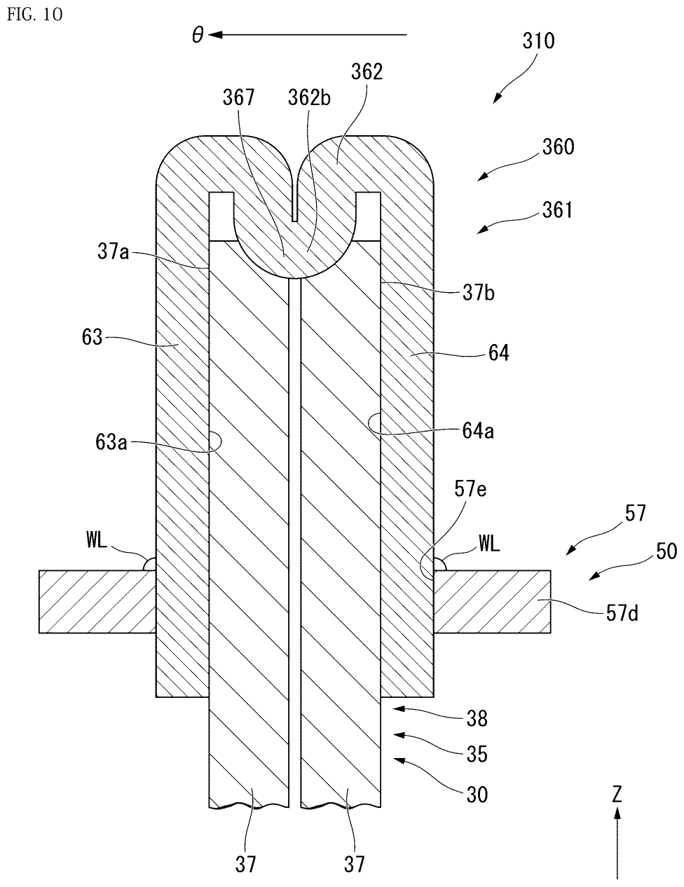

As illustrated in FIG. 10, the housing portion 361 accommodates the coil lead wire group 38 in the inside. That is, the housing portion 361 accommodates the coil lead wire 37 in the inside. The housing portion 361 includes a top wall portion 362 and side wall portions 63 and 64. As illustrated in FIG. 9, the top wall portion 362 has a plate shape expanding in the axial direction, that is, in a direction intersecting a direction in which the coil lead wire 37 extends. When viewed from the axial direction, the top wall portion 362 has a substantially rectangular shape whose long side extends in a direction orthogonal to the radial direction. The top wall portion 362 has a curved portion 362b. The curved portion 362b is a portion at the circumferential center of the top wall portion 362. The curved portion 362b is curved downward. The curved portion 362b protrudes toward the inside of the housing portion 361. In the present embodiment, the pressing portion 367 is a curved portion 362b.

A configuration and the like of the side wall portions 63 and 64 of the present embodiment are similar to a configuration and the like of the side wall portions 63 and 64 of the first embodiment described above. As illustrated in FIG. 10, each of the side wall portions 63 and 64 is press-fitted into the hole portion 57e. Accordingly, the connection member 360 and the bus bar 56 can be electrically connected to each other. Therefore, the connection member 360 is electrically connected to the substrate 80 via the bus bar 56 and the connection terminal 83. Each of the side wall portions 63 and 64 is fixed to the terminal portion 57d by welding. By this, the connection member 360 is fixed to the terminal portion 57d. The side wall portion 63 has the first inner surface 63a, and the side wall portion 64 has the first inner surface 64a. An inner surface of the housing portion 361 includes the first inner surfaces 63a and 64a.

The coil lead wire group 38 passes through the hole portion 57e in the axial direction, and is arranged inside the housing portion 361. The first inner surface 63a faces a first coil side surface 37a of one of the coil lead wires 37. The first inner surface 64a faces a second coil side surface 37b of another one of the coil lead wires 37. Each of the first coil side surface 37a and the second coil side surface 37b is a side surface of the coil lead wire 37. Therefore, the first inner surfaces 63a and 64a face a side surface of the coil lead wire 37.

A tip portion of one of the coil lead wires 37 is arranged between the side wall portion 63 and the pressing portion 367. A tip portion of one of the coil lead wires 37 is press-fitted into the first inner surface 63a and the pressing portion 367. By this, the pressing portion 367 presses the first coil side surface 37a of one of the coil lead wires 37 against the first inner surface 63a. A tip portion of another one of the coil lead wires 37 is arranged between the side wall portion 64 and the pressing portion 367. A tip portion of another one of the coil lead wires 37 is press-fitted into the first inner surface 64a and the pressing portion 367. By this, the pressing portion 367 presses the second coil side surface 37b of another one of the coil lead wires 37 against the first inner surface 64a. Therefore, the pressing portion 367 presses a side surface of the coil lead wire 37 against the first inner surfaces 63a and 64a. By this, each of the coil lead wires 37 is electrically connected to the connection member 360. Therefore, the coil portion 35 is electrically connected to the substrate 80. The other configurations and the like of the connection member 360 of the present embodiment are similar to the other configurations and the like of the connection member 60 of the first embodiment described above. The other configurations and the like of the rotating electrical machine 310 of the present embodiment are similar to the other configurations and the like of the rotating electrical machine 10 of the first embodiment described above.

As described above, in the present embodiment, each of the connection member 360 and the bus bar 56 is made from the second material M2. For this reason, as in the first embodiment described above, the connection member 360 can be firmly fixed to the bus bar 56 by welding. Therefore, even in a case where the coil portion 35 and the bus bar 56 are made from materials different from each other, the coil portion 35 and the bus bar 56 can be stably and electrically connected via the connection member 360.

According to the present embodiment, the housing portion 361 has the top wall portion 362 expanding in the axial direction, that is, in a direction intersecting a direction in which the coil lead wire 37 extends, an inner surface of the housing portion 361 includes the first inner surfaces 63a and 64a facing a side surface of the coil lead wire 37, the top wall portion 362 has the curved portion 362b protruding toward the inside of the housing portion 361, and the pressing portion 367 is the curved portion 362b and presses a side surface of the coil lead wire 37 against the first inner surfaces 63a and 64a. Therefore, since a contact area between the coil lead wire 37 and the connection member 360 is easily made large, it is possible to suppress increase in contact resistance between the coil lead wire 37 and the connection member 360. Therefore, even in a case where the coil portion 35 and the bus bar 56 are made from materials different from each other, the coil portion 35 and the bus bar 56 can be more stably and electrically connected via the connection member 360.

Further, in the present embodiment, since the pressing portion 367 is the curved portion 362b curved toward the inside of the housing portion 361 in the top wall portion 362, the connection member 360 can be manufactured by pressing a plate-shaped member. For this reason, manufacturing cost of the connection member 360 can be easily reduced. Therefore, increase in manufacturing cost of the rotating electric machine 310 can be suitably suppressed.

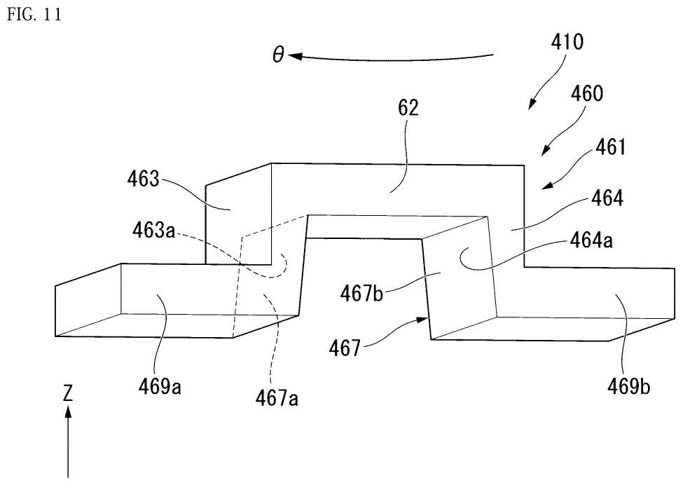

As illustrated in FIG. 11, a rotating electrical machine 410 of the present embodiment includes a connection member 460. In description below, the same reference numerals are given to constituent elements of the same aspects as those of the above-described embodiment, and the description of those will be omitted.

The connection member 460 illustrated in FIG. 11 is made from copper. Each of the connection member 460 and the bus bar 56 is made from the second material M2. Although not illustrated, the rotating electrical machine 410 includes three of the connection members 460. The connection members 460 are fixed to the terminal portions 57d, 58d, and 59d different from each other. That is, the connection member 460 is fixed to the bus bar 56. The connection member 460 includes a housing portion 461, a pressing portion 467, and protruding portions 469a and 469b.

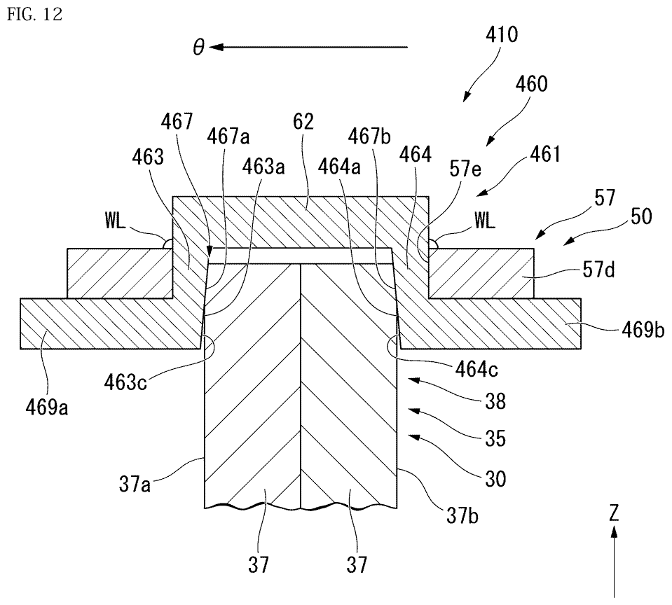

As illustrated in FIG. 12, the housing portion 461 accommodates the coil lead wire group 38 in the inside. That is, the housing portion 461 accommodates the coil lead wire 37 in the inside. The housing portion 461 includes the top wall portion 62 and side wall portions 463 and 464. A configuration and the like of the top wall portion 62 of the present embodiment are similar to a configuration and the like of the top wall portion 62 of the first embodiment described above.

As illustrated in FIG. 11, the side wall portion 463 has a plate shape extending downward from an end portion on the one side in the circumferential direction (+θ side) of the top wall portion 62. The side wall portion 464 has a plate shape extending downward from an end portion on the another side in the circumferential direction (−θ side) of the top wall portion 62. As illustrated in FIG. 12, each of the side wall portions 463 and 464 is press-fitted into the hole portion 57e. Accordingly, the connection member 460 and the bus bar 56 can be electrically connected to each other. Therefore, the connection member 460 is electrically connected to the substrate 80 via the bus bar 56 and the connection terminal 83. Each of the side wall portions 463 and 464 is fixed to the terminal portion 57d by welding. The joint portion WL illustrated in FIG. 12 is a portion where a part of each of the side wall portions 463 and 464 and a part of the terminal portion 57d are joined by welding. As described above, each of the bus bar 56 and the connection member 460 is made from copper. Therefore, in the present embodiment, the connection member 460 can be firmly fixed to the bus bar 56 by welding.

The side wall portion 463 has a first inner surface 463a. The first inner surface 463a is a surface facing the another side in the circumferential direction (−θ side) of the side wall portion 463. The side wall portion 464 has a second inner surface 464a. The second inner surface 464a is a surface facing the one side in the circumferential direction (+0 side) of the side wall portion 464. An inner surface of the housing portion 461 includes the first inner surface 463a and the second inner surface 464a.

The first inner surface 463a has a first inclined surface 463c. The first inclined surface 463c is an inclined surface located closer to the second inner surface 464a side as it approaches the upper side, that is, the tip side of the coil lead wire 37. In the present embodiment, the first inclined surface 463c is the entire first inner surface 463a. The first inclined surface 463c may be, for example, a portion on the upper side of the first inner surface 463a. In this case, a portion on the lower side of the first inner surface 463a faces, for example, a direction orthogonal to the radial direction.

The second inner surface 464a has a second inclined surface 464c. The second inclined surface 464c is an inclined surface located closer to the first inner surface 463a side as it approaches the upper side, that is, the tip side of the coil lead wire 37. In the present embodiment, the second inclined surface 464c is the entire second inner surface 464a. The second inclined surface 464c may be, for example, a portion on the upper side of the second inner surface 464a. In this case, a portion on the lower side of the second inner surface 464a faces, for example, a direction orthogonal to the radial direction. The other configurations and the like of the side wall portions 463 and 464 of the present embodiment are similar to the other configurations and the like of the side wall portions 63 and 64 of the first embodiment described above.

In the present embodiment, the pressing portion 467 includes a first pressing portion 467a and a second pressing portion 467b. The first pressing portion 467a is the first inclined surface 463c. The second pressing portion 467b is the second inclined surface 464c. Therefore, in the present embodiment, the pressing portion 467 is the first inclined surface 463c and the second inclined surface 464c.

The coil lead wire group 38 passes through the hole portion 57e in the axial direction, and is arranged inside the housing portion 461. A side surface of the coil lead wire 37 includes the first coil side surface 37a and the second coil side surface 37b. The first coil side surface 37a is a surface facing the one side in the circumferential direction (+θ side) in a side surface of one of the coil lead wires 37. The second coil side surface 37b is a surface facing the another side in the circumferential direction (−θ side) in a side surface of another one of the coil lead wires 37. The second coil side surface 37b faces the side opposite to the first coil side surface 37a. The first inner surface 463a faces the first coil side surface 37a. The second inner surface 464a faces the second coil side surface 37b.

A dimension in a direction orthogonal to the radial direction of the coil lead wire group 38 is larger than a dimension between an upper end of the first pressing portion 467a and an upper end of the second pressing portion 467b. For this reason, a tip portion of the coil lead wire group 38 is press-fitted into the first pressing portion 467a and the second pressing portion 467b. By this, the first pressing portion 467a presses the second coil side surface 37b against the second pressing portion 467b. The second pressing portion 467b presses the first coil side surface 37a against the first pressing portion 467a. By these, the pressing portion 467 presses the first coil side surface 37a against the first inner surface 463a and presses the second coil side surface 37b against the second inner surface 464a. That is, the pressing portion 467 presses a side surface of the coil lead wire 37 against an inner surface of the housing portion 461. By this, each of the coil lead wires 37 is electrically connected to the connection member 460. Therefore, the coil portion 35 is electrically connected to the substrate 80.

The protruding portion 469a protrudes from a lower end of the side wall portion 463 to the one side in the circumferential direction (+θ side). The protruding portion 469b protrudes from a lower end of the side wall portion 464 to the another side in the circumferential direction (−θ side). A surface facing the upper side of each of the protruding portions 469a and 469b contacts a surface facing the lower side of the terminal portion 57d in the axial direction. By this, a position in the axial direction of the connection member 460 with respect to the terminal portion 57d is determined. The other configurations and the like of the connection member 460 of the present embodiment are similar to the other configurations and the like of the connection member 60 of the first embodiment described above. The other configurations and the like of the rotating electrical machine 410 of the present embodiment are similar to the other configurations and the like of the rotating electrical machine 10 of the first embodiment described above.

As described above, in the present embodiment, each of the connection member 460 and the bus bar 56 is made from the second material M2. For this reason, as in the first embodiment described above, the connection member 460 can be firmly fixed to the bus bar 56 by welding. Therefore, even in a case where the coil portion 35 and the bus bar 56 are made from materials different from each other, the coil portion 35 and the bus bar 56 can be stably and electrically connected via the connection member 460.

According to the present embodiment, a side surface of the coil lead wire 37 includes the first coil side surface 37a and the second coil side surface 37b facing the side opposite to the first coil side surface 37a, an inner surface of the housing portion 461 includes the first inner surface 463a facing the first coil side surface 37a and the second inner surface 464a facing the second coil side surface 37b, the first inner surface 463a has the first inclined surface 463c located closer to the second inner surface 464a side as it approaches the tip side of the coil lead wire 37, the second inner surface 464a has the second inclined surface 464c located closer to the first inner surface 463a side as it approaches the tip side of the coil lead wire 37, and the pressing portion 467 is the first inclined surface 463c and the second inclined surface 464c, and presses the first coil side surface 37a against the first inner surface 463a, and presses the second coil side surface 37b against the second inner surface 464a. For this reason, a side surface of one of the coil lead wires 37 and a side surface of another one of the coil lead wires 37 can be pressed against an inner surface of the connection member 460 by the pressing portion 467. By this, since a contact area between two of the coil lead wires 37 and the connection member 460 is easily made large, it is possible to suppress increase in contact resistance between the coil lead wire 37 and the connection member 460. Therefore, even in a case where the coil portion 35 and the bus bar 56 are made from materials different from each other, the coil portion 35 and the bus bar 56 can be more stably and electrically connected via the connection member 460.

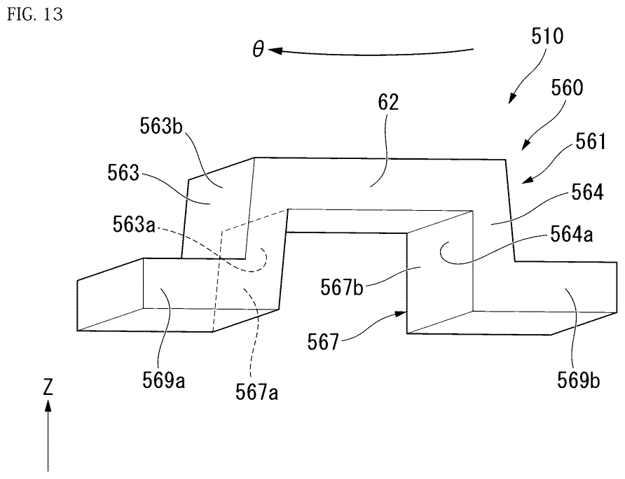

As illustrated in FIG. 13, a rotating electrical machine 510 of the present embodiment includes a connection member 560. In description below, the same reference numerals are given to constituent elements of the same aspects as those of the above-described embodiment, and the description of those will be omitted.

The connection member 560 illustrated in FIG. 13 is made from copper. Each of the connection member 560 and the bus bar 56 is made from the second material M2. Although not illustrated, the rotating electrical machine 510 includes three of the connection members 560. The connection members 560 are fixed to the terminal portions 57d, 58d, and 59d different from each other. That is, the connection member 560 is fixed to the bus bar 56. The connection member 560 includes a housing portion 561, a pressing portion 567, and protruding portions 569a and 569b.

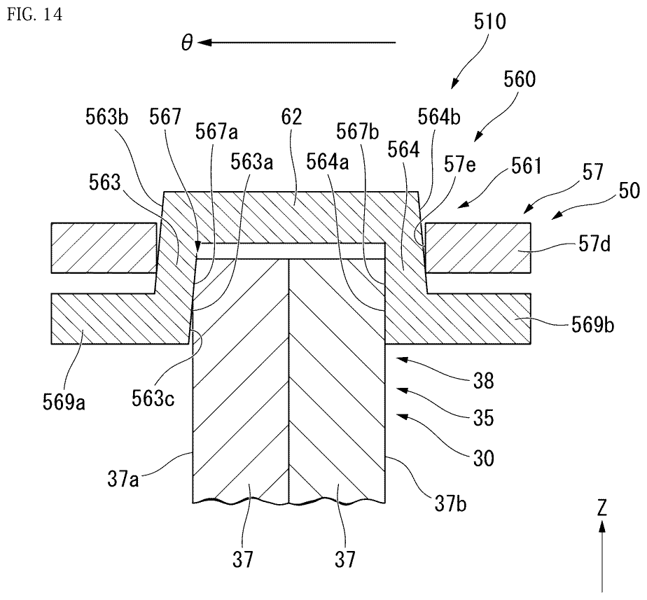

As illustrated in FIG. 14, the housing portion 561 accommodates the coil lead wire group 38 in the inside. That is, the housing portion 561 accommodates the coil lead wire 37 in the inside. The housing portion 561 includes the top wall portion 62 and side wall portions 563 and 564. A configuration and the like of the top wall portion 62 of the present embodiment are similar to a configuration and the like of the top wall portion 62 of the first embodiment described above.

As illustrated in FIG. 13, the side wall portion 563 has a plate shape extending downward from an end portion on the one side in the circumferential direction (+θ side) of the top wall portion 62. The side wall portion 564 has a plate shape extending downward from an end portion on the another side in the circumferential direction (−θ side) of the top wall portion 62. As illustrated in FIG. 14, each of the side wall portions 563 and 564 passes through the hole portion 57e in the axial direction.

The side wall portion 563 has a first inner surface 563a and a first outer surface 563b. The first inner surface 563a is a surface facing the another side in the circumferential direction (−θ side) of the side wall portion 563. The first outer surface 563b is a surface facing the one side in the circumferential direction (+θ side) of the side wall portion 563. The side wall portion 564 has a second inner surface 564a and a second outer surface 564b. The second inner surface 564a is a surface facing the one side in the circumferential direction of the side wall portion 564. The second outer surface 564b is a surface facing the another side in the circumferential direction of the side wall portion 564, and an inner surface of the housing portion 561 includes the first inner surface 563a and the second inner surface 564a.

The first inner surface 563a has a first inclined surface 563c. The first inclined surface 563c is an inclined surface located closer to the second inner surface 564a side as it approaches the upper side, that is, the tip side of the coil lead wire 37. In the present embodiment, the first inclined surface 563c is the entire first inner surface 563a. The first inclined surface 563c may be, for example, a portion on the upper side of the first inner surface 563a. In this case, a portion on the lower side of the first inner surface 563a faces, for example, a direction orthogonal to the radial direction. In the present embodiment, the entire second inner surface 564a faces a direction orthogonal to the radial direction.

The first outer surface 563b is an inclined surface located closer to the second inner surface 564a side as it approaches the upper side. The second outer surface 564b is an inclined surface located closer to the first inner surface 563a side as it approaches the upper side. By these, a dimension in the circumferential direction of the housing portion 561 decreases as it approaches the upper side, that is, the tip side of the coil lead wire 37. That is, a dimension in the axial direction of the housing portion 561, that is, a direction intersecting a direction in which the coil lead wire 37 extends is smaller as it approaches the upper side. In the present embodiment, each of the side wall portions 563 and 564 is press-fitted into the hole portion 57e. By this, the connection member 560 is fixed to the bus bar 56. Further, the connection member 560 and the bus bar 56 can be electrically connected to each other. Therefore, the connection member 560 is electrically connected to the substrate 80 via the bus bar 56 and the connection terminal 83.

In the present embodiment, the pressing portion 567 includes a first pressing portion 567a and a second pressing portion 567b. The first pressing portion 567a is the first inclined surface 563c. The second pressing portion 567b is the second inner surface 464a. The other configurations and the like of the side wall portions 563 and 564 of the present embodiment are similar to the other configurations and the like of the side wall portions 463 and 464 of the fourth embodiment described above.

The coil lead wire group 38 is arranged inside the housing portion 561. A side surface of the coil lead wire 37 includes the first coil side surface 37a and the second coil side surface 37b. A dimension in a direction orthogonal to the radial direction of the coil lead wire group 38 is larger than a dimension between an upper end of the first pressing portion 567a and an upper end of the second pressing portion 567b. For this reason, a tip portion of the coil lead wire group 38 is press-fitted into the first pressing portion 567a and the second pressing portion 567b. By this, the pressing portion 567 presses the first coil side surface 37a against the first inner surface 563a and presses the second coil side surface 37b against the second inner surface 564a. That is, the pressing portion 567 presses a side surface of the coil lead wire 37 against an inner surface of the housing portion 561. By this, each of the coil lead wires 37 is electrically connected to the connection member 560. Therefore, the coil portion 35 is electrically connected to the substrate 80. The other configurations and the like of the coil lead wire group 38 of the present embodiment are similar to the other configurations and the like of the coil lead wire group 38 of the fourth embodiment described above.

The protruding portion 569a protrudes from a lower end of the side wall portion 563 to the one side in the circumferential direction (+θ side). The protruding portion 569b protrudes from a lower end of the side wall portion 564 to the another side in the circumferential direction (−θ side). A surface facing the upper side of each of the protruding portions 569a and 569b faces a surface facing the lower side of the terminal portion 57d in the axial direction. In the present embodiment, each of the protruding portions 569a and 569b is arranged with a gap from the terminal portion 57d in the axial direction. Each of the protruding portions 569a and 569b may be in contact with the terminal portion 57d in the axial direction. The other configurations and the like of the connection member 560 of the present embodiment are similar to the other configurations and the like of the connection member 460 of the fourth embodiment described above. The other configurations and the like of the rotating electrical machine 510 of the present embodiment are similar to the other configurations and the like of the rotating electrical machine 410 of the fourth embodiment described above.

According to the present embodiment, a dimension in the axial direction, that is, a direction intersecting the direction in which the coil lead wire 37 extends of the housing portion 561 is smaller as it approaches the upper side, that is, the tip side of the coil lead wire 37. Therefore, when the connection member 560 is attached to the bus bar 56 in a manufacturing process of the rotating electrical machine 510, the housing portion 561 can be press-fitted and fixed to the hole portions 57e, 58e, and 59e by simple work of inserting the housing portion 561 into the hole portions 57e, 58e, and 59e from below. Therefore, it is possible to suitably suppress increase in the number of manufacturing steps of the rotating electrical machine 510.

The present disclosure is not limited to the above-described embodiment, and other configurations and other methods can be employed within the scope of the technical idea of the present disclosure. For example, if the connection member and the bus bar can be firmly joined by welding, that is, if a difference between a melting point of the connection member and a melting point of the bus bar is small, the connection member may be made from a material different from each of the first material and the second material.

Further, the number of the coil lead wires accommodated in the housing portion may be one or three or more. Even in these cases, the pressing portion presses a side surface of each of the coil lead wires against an inner surface of the housing portion, so that electrical connection between each of the coil lead wires and the connection member can be stabilized.

The rotating electrical machine to which the present disclosure is applied is not limited to a motor, and may be a generator. The application of the rotating electrical machine is not particularly limited. The rotating electrical machine may be mounted in equipment other than a vehicle. The application of the rotating electrical machine to which the present disclosure is applied is not particularly limited. The rotating electrical machine may be mounted on a vehicle for applications other than an application of rotating an axle for example, or may be mounted on equipment other than a vehicle.

While one embodiment of the present disclosure is described above, configurations, a combination of the configurations, and the like according to the embodiment are merely an example, and an addition, elimination, and substitution of a configuration, and other modifications can be made without departing from the spirit of the present disclosure. Further, the present disclosure is not limited by the embodiment.

Note that the present technique can have a configuration as described below.
(1) A rotating electrical machine including a rotor rotatable about a central axis, a stator including a coil portion made from a first material and facing the rotor with a gap interposed between them, a substrate that supplies power to the coil portion, a bus bar electrically connected to the substrate and made from a second material different from the first material, and a connection member that is fixed to the bus bar and electrically connects the coil portion and the bus bar, in which the coil portion includes a coil main body portion mounted on the stator and a coil lead wire drawn out from the coil main body portion, and the connection member includes a housing portion that accommodates the coil lead wire therein, and a pressing portion that presses the coil lead wire against an inner surface of the housing portion.
(2) The rotating electrical machine according to (1), in which an inner surface of the housing portion includes a top surface expanding in a direction intersecting a direction in which the coil lead wire extends, and a first inner surface facing a side surface of the coil lead wire, and the pressing portion is a protrusion that protrudes from the top surface and presses a side surface of the coil lead wire against the first inner surface.
(3) The rotating electrical machine according to (1), in which a side surface of the coil lead wire includes a first coil side surface and a second coil side surface facing a side opposite to the first coil side surface, an inner surface of the housing portion includes a first inner surface facing the first coil side surface, and a second inner surface facing the second coil side surface, the first inner surface has an inclined surface located closer to the second inner surface side as the inclined surface approaches a tip side of the coil lead wire, and the pressing portion is the inclined surface and presses the second coil side surface against the second inner surface.
(4) The rotating electrical machine according to (1), in which a side surface of the coil lead wire includes a first coil side surface and a second coil side surface facing a side opposite to the first coil side surface, an inner surface of the housing portion includes a first inner surface facing the first coil side surface, and a second inner surface facing the second coil side surface, the first inner surface has a first inclined surface located closer to the second inner surface side as the first inner surface approaches a tip side of the coil lead wire, the second inner surface has a second inclined surface located closer to the first inner surface side as the second inner surface approaches a tip side of the coil lead wire, and the pressing portion is the first inclined surface and the second inclined surface, presses the first coil side surface against the first inner surface, and presses the second coil side surface against the second inner surface.
(5) The rotating electrical machine according to (1), in which the housing portion includes a top wall portion expanding in a direction intersecting a direction in which the coil lead wire extends, an inner surface of the housing portion includes a first inner surface facing a side surface of the coil lead wire, the top wall portion includes a curved portion protruding toward inside of the housing portion, and the pressing portion is the curved portion, and presses a side surface of the coil lead wire against the first inner surface.
(6) The rotating electrical machine according to any one of (1) to (5), in which the bus bar has a hole portion through which the connection member passes, and the connection member is press-fitted into the hole portion.
(7) The rotating electrical machine according to any one of (1) to (6), in which a dimension in a direction intersecting a direction in which the coil lead wire extends of the housing portion is smaller as the housing portion approaches a tip side of the coil lead wire.
(8) The rotating electrical machine according to any one of (1) to (7), in which the connection member is made from the second material, and is fixed to the bus bar by welding.
(9) The rotating electrical machine according to (8), in which the connection member includes a protruding portion that protrudes from the housing portion toward the outside of the housing portion, and the protruding portion is fixed to the bus bar by welding.

Features of the above-described preferred embodiments and the modifications thereof may be combined appropriately as long as no conflict arises.

While preferred embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

What is claimed is:

1. A rotating electrical machine comprising:
a rotor rotatable about a central axis;
a stator including a coil portion made from a first material and facing the rotor with a gap interposed therebetween;
a substrate that supplies power to the coil portion;
a bus bar electrically connected to the substrate and made from a second material different from the first material; and
a connection member that is fixed to the bus bar and electrically connects the coil portion and the bus bar, wherein
the coil portion includes a coil main body portion mounted on the stator and a coil lead wire drawn out from the coil main body portion, and
the connection member includes a housing portion that accommodates the coil lead wire therein, and a pressing portion that presses the coil lead wire against an inner surface of the housing portion.

2. The rotating electrical machine according to claim 1, wherein
an inner surface of the housing portion includes:
a top surface expanding in a direction intersecting a direction in which the coil lead wire extends; and
a first inner surface facing a side surface of the coil lead wire, and
the pressing portion is a protrusion that protrudes from the top surface and presses a side surface of the coil lead wire against the first inner surface.

3. The rotating electrical machine according to claim 1, wherein
a side surface of the coil lead wire includes a first coil side surface and a second coil side surface facing a side opposite to the first coil side surface,
an inner surface of the housing portion includes:
a first inner surface facing the first coil side surface; and
a second inner surface facing the second coil side surface,
the first inner surface has an inclined surface located closer to the second inner surface side as the inclined surface approaches a tip side of the coil lead wire, and
the pressing portion is the inclined surface and presses the second coil side surface against the second inner surface.

4. The rotating electrical machine according to claim 1, wherein
a side surface of the coil lead wire includes a first coil side surface and a second coil side surface facing a side opposite to the first coil side surface,
an inner surface of the housing portion includes:
a first inner surface facing the first coil side surface; and
a second inner surface facing the second coil side surface,
the first inner surface has a first inclined surface located closer to the second inner surface side as the first inner surface approaches a tip side of the coil lead wire,
the second inner surface has a second inclined surface located closer to the first inner surface side as the second inner surface approaches a tip side of the coil lead wire, and
the pressing portion is the first inclined surface and the second inclined surface, presses the first coil side surface against the first inner surface, and presses the second coil side surface against the second inner surface.

5. The rotating electrical machine according to claim 1, wherein
the housing portion includes a top wall portion expanding in a direction intersecting a direction in which the coil lead wire extends,
an inner surface of the housing portion includes a first inner surface facing a side surface of the coil lead wire,
the top wall portion includes a curved portion protruding toward inside of the housing portion, and
the pressing portion is the curved portion, and presses a side surface of the coil lead wire against the first inner surface.

6. The rotating electrical machine according to claim 1, wherein
the bus bar has a hole portion through which the connection member passes, and
the connection member is press-fitted into the hole portion.

7. The rotating electrical machine according to claim 1, wherein a dimension in a direction intersecting a direction in which the coil lead wire extends of the housing portion is smaller as the housing portion approaches a tip side of the coil lead wire.

8. The rotating electrical machine according to claim 1, wherein the connection member is made from the second material, and is fixed to the bus bar by welding.

9. The rotating electrical machine according to claim 8, wherein
the connection member includes a protruding portion that protrudes from the housing portion toward outside of the housing portion, and
the protruding portion is fixed to the bus bar by welding.
